(19) United States
(12) Patent Application Publication
(10) Pub. No.: US 2018/0262729 A1
(43) Pub. Date: Sep. 13, 2018

(54) VIDEO DISPLAY APPARATUS AND PROJECTION UNIT

(71) Applicant: CANON KABUSHIKI KAISHA, Tokyo (JP)

(72) Inventor: Takashi Ohki, Utsunomiya-shi (JP)

(21) Appl. No.: 15/913,027

(22) Filed: Mar. 6, 2018

(30) Foreign Application Priority Data
Mar. 10, 2017 (JP) 2017-045909

(51) Int. Cl. H04N 9/31; H04N 9/79; H04N 7/01

(52) U.S. Cl. CPC H04N 9/3191; H04N 9/79; H04N 9/3188; H04N 7/0127; H04N 7/0117

(57) ABSTRACT

The video display apparatus displays video using a video signal input from an external apparatus. The video display apparatus includes a video inputter configured to receive the video signal, and a communicator configured to perform wireless communication. The video display apparatus further includes a controller configured to perform, using information on a communication frequency band of the wireless communication, a set process to set a format of the video signal receivable by the video signal apparatus.

### BACKGROUND OF THE INVENTION

### Field of the Invention

The present invention relates to a video display apparatus such as a projection unit having a wireless communication function.

### Description of the Related Art

Video display apparatuses include ones each having a wireless communication function and capable of receiving a video signal from an external apparatus. In such video display apparatuses, their operation frequency increases due to an increase in definition and resolution of displayed video, and thereby cases increase where noise in the apparatus (hereinafter referred to as “in-apparatus noise”) caused by the video signal affects operations of the apparatus. Furthermore, the in-apparatus noise includes not only noise having a frequency of a noise source, but also harmonic noise whose frequency is an integral multiple of the frequency of the noise source. Such harmonic noise included in a frequency band used in a wireless communication interferes the wireless communication, which may generate communication failures such as a communication disability and a decrease in communication speed.

Japanese Patent Laid-Open No. 2013-109272 discloses a method for reducing in-apparatus noise. The method makes a transmission clock frequency of a signal, which is transmitted from a controller to a driver such as an LCD driver, different from a video signal received by the controller from an external apparatus.

However, it is difficult for the method disclosed in Japanese Patent Laid-Open No. 2013-109272 to deal with video signals transmitted from various external apparatuses and having various formats.

### SUMMARY OF THE INVENTION

The present invention provides a video display apparatus capable of reducing wireless communication failures caused by video signals input from external apparatuses.

The present invention provides as an aspect thereof a video display apparatus configured to display video using a video signal input from an external apparatus. The video display apparatus includes a video inputter configured to receive the video signal, a communicator configured to perform wireless communication, and a controller configured to perform, using information on a communication frequency band of the wireless communication, a set process to set format of the video signal receivable by the video display apparatus.

The present invention provides as another aspect thereof a projection unit configured to project and display video using a video signal input from an external apparatus. The projection unit includes a light modulator that is driven by a drive signal produced using the video signal to modulate light from a light source; and an optical system that projects the light modulated by the light modulator to a projection surface. The projection unit further includes a video inputter configured to receive the video signal from the external apparatus, a communicator configured to perform wireless communication, and a controller configured to perform, using information on a communication frequency band of the wireless communication, a set process to set a format of the video signal receivable by the projection unit.

The present invention provides as yet another aspect thereof a computer program for causing a computer of the video display apparatus to perform the above set process.

Further features of the present invention will become apparent from the following description of exemplary embodiments with reference to the attached drawings.

### BRIEF DESCRIPTION OF THE DRAWINGS

FIG. 1 is a block diagram illustrating a configuration of a projection unit that is Embodiment 1 of the present invention.

FIG. 2 illustrates communication frequency bands in Embodiment 1.

FIG. 3 is a flowchart of a format change process in Embodiment 1.

FIG. 4 illustrates that a harmonic noise is included in the communication frequency band.

FIG. 5 illustrates that the harmonic noise is out of the communication frequency band by the format change process.

FIG. 6 is a block diagram illustrating a configuration of a projection unit that is Embodiment 2 of the present invention.

FIG. 7 is a block diagram illustrating a configuration of a projection unit that is Embodiment 3 of the present invention.

FIG. 8 is a flowchart of a format change process in Embodiment 3.

### DESCRIPTION OF THE EMBODIMENTS

Exemplary embodiments of the present invention will hereinafter be described with reference to the accompanying drawings.

### Embodiment 1

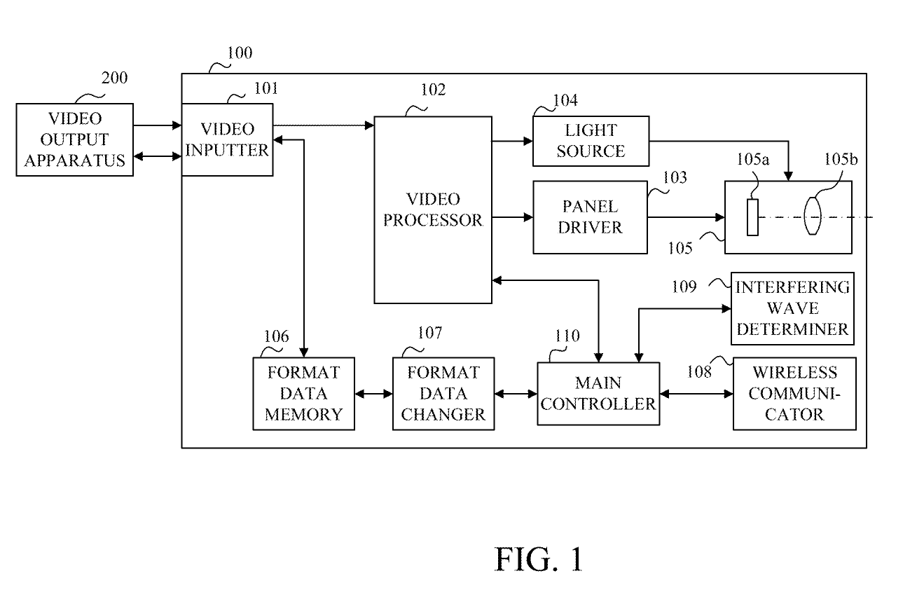

FIG. 1 illustrates a configuration of a projection unit 100 as a video display apparatus that is a first embodiment (Embodiment 1) of the present invention. The projection unit 100 includes a video inputter 101, a video processor 102, a panel driver 103, a light source 104 and a projection unit 105. The projection unit 100 further includes a format data memory 106, a format data changer 107, a wireless communicator 108, an interfering wave determiner 109 and a main controller 110. The format data changer 107, the interfering wave determiner 109 and the main controller 110 constitute a controller.

The projection unit 105 includes an illumination optical system, a color separation optical system, a light modulator 105a, a color combination optical system and a projection optical system 105b. The light source 104 includes a light emitter such as a discharge lamp (for example, a mercury lamp) or a laser diode. The illumination optical system converts light from the light source 104 into an illumination light evenly projected to a rectangle illumination area. The color separation optical system separates the illumination light (white light) into a red light, a blue light and a green light to introduce them to the light modulator 105a including one or more liquid crystal panels or a digital micromirror device.

The light modulator 105a is driven by a panel drive signal produced by the panel driver 103 depending on the video signal input from the video processor 102 to modulate the entering red, blue and green lights. The color combination optical system combines the red, blue and green lights modulated by the light modulator 105a to introduce the combined lights as an image light to the projection optical system 105b.

The projection optical system 105b projects the image light to a projection surface (not illustrated) such as a screen. Thereby, a color projected video is displayed.

The video inputter 101 includes a connector for connecting the projection unit 100 with a video output apparatus 200 as an external apparatus such as a personal computer that outputs the video signal via a cable. The video output apparatus 200 is capable of outputting video signals of various formats (or specifications). Although FIG. 1 illustrates one video output apparatus 200, the video inputter 101 can be connected with various video output apparatuses (external apparatuses). The video processor 102 decodes the video signal input from the video inputter 101. The video processor 102 further performs various video processes on the input video signal to output the video signal subjected to the video processes to the panel driver 103.

The video processor 102 further sends, to the video output apparatus 200, when the format of the input video signal has been changed by the controller 110 or the like, a request for reconnecting with the projection unit 100 or a request for changing the format of the video signal transmitted to the projection unit 100. The panel driver 103 converts the video signal from the video processor 102 into the panel drive signal to input it to the light modulator 105a.

The format data memory 106 is a memory for EDID (Extended Display Identification Data) using an EEPROM or the like.

The format data memory 106 stores information on the format of the video signal inputtable to, that is, receivable by the video inputter 101. The format of the video signal includes a resolution, horizontal and vertical blanking periods, a clock (dot clock) frequency and others.

In the following description, the format of the video signal is referred to as “a video format”, and the information on the video format is referred to as “video format data”.

The video output apparatus 200 connected to the projection unit 100 via the cable acquires the video format data stored in the format data memory 106 to confirm the video format receivable by the projection unit 100. Then, the video output apparatus 200 outputs the video signal of the receivable video format to the video inputter 101.

The format data changer 107 performs a format change process for changing the video format stored in the format data memory 106. Performing the format change process enables notifying various external apparatuses including the video output apparatus 200 of the video format data of the video signal receivable by the projection unit 100.

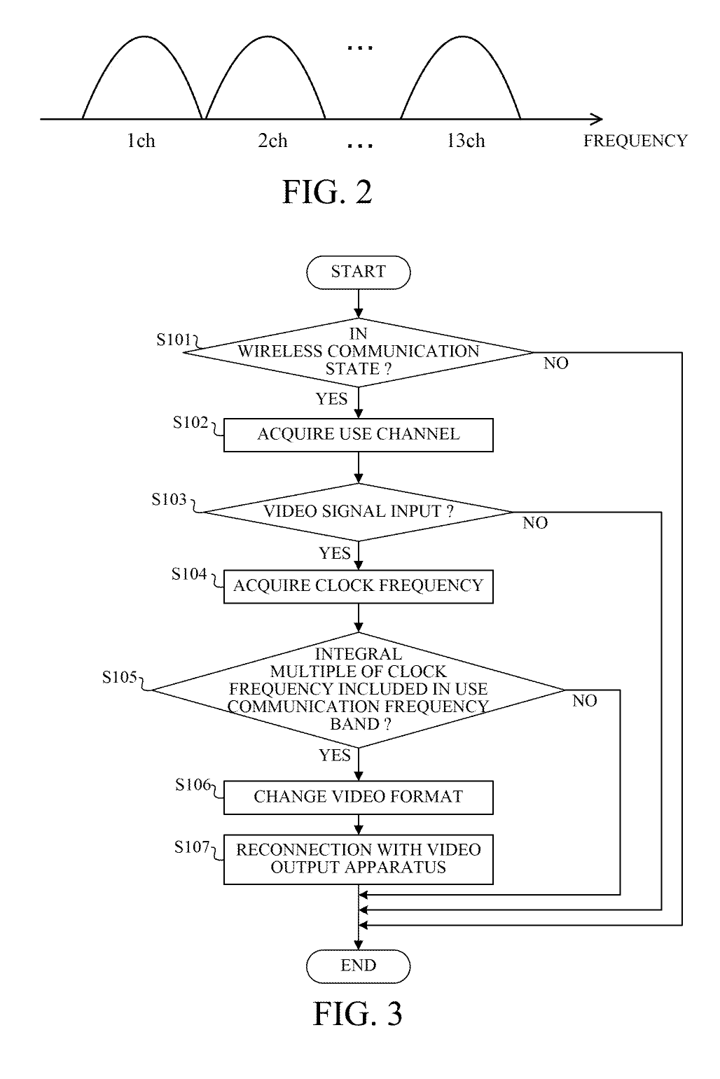

The wireless communicator 108 is a wireless LAN module for performing wireless communication with external communication devices. The wireless communicator 108 performs external wireless communication using any of multiple communication frequency bands (1ch, 2ch, . . . , and 13ch) illustrated in FIG. 2.

Although FIG. 2 illustrates the case where the multiple communication frequency bands do not mutually overlap, the multiple communication frequency bands may mutually partially overlap.

The interfering wave determiner 109 determines whether or not any of frequencies as integral multiples of the clock frequency that is one element of the video format of the video signal input to the video processor 102 is included in a communication frequency band (hereinafter referred to as “a use communication frequency band”) used in the wireless communication by the wireless communicator 108. That is, the interfering wave determiner 109 determines whether or not a frequency of an interfering wave as harmonic noise whose frequency is one of the integral multiples of the clock frequency is included in the use communication frequency band.

Then, when determining that the frequency of the interfering wave is included in the use communication frequency band, the interfering wave determiner 109 sends this determination result to the controller 110. The interfering wave is noise relating to the video signal, in other words, noise relating to the format (particularly to the clock frequency) of the video signal.

The controller 110 having received the determination result indicating that the interfering wave is included in the use communication frequency band causes the format data changer 107 to perform the above-described format change process. Specifically, the controller 110 causes the format data changer 107 to perform the format change process such that the frequency as the integral multiple of the clock frequency included in the changed video format data is not included in the use communication frequency band of the wireless communicator 108. The controller 110 further controls the video processor 102, the panel driver 103 and the light source 104.

Next, description will be made of a video input process performed by the controller 110 with reference to a flowchart illustrated in FIG. 3. In the following description, character “S” denotes a step (process). The controller 110 constituted by a computer such as a CPU executes this process according to a video input process program as a computer program.

First at S101, the controller 110 confirms whether or not the wireless communicator 108 is in a wireless communication state of performing wireless communication with an external communication device. The controller 110 having confirmed that the wireless communicator 108 is in the wireless communication state proceeds to S102 to acquire information on channel (use channel) used by the wireless communicator 108, and then proceeds to S103.

S103, the controller 110 confirms whether or not the video signal is being input thereto via the video inputter 101.

If the video signal is being input, the controller 110 proceeds to S104. At S104, the controller 110 acquires data (video format data) on the clock frequency of the video signal input to the video processor 102 and proceeds to S105.

At step S105, the controller 110 causes the interfering wave determiner 109 to perform an interfering wave (noise) determination process. Specifically, as described above, the interfering wave determiner 109 determines whether or not a frequency (multiplied frequency) that is any of the integral multiples of the clock frequency is included in the use communication frequency band of the wireless communicator 108. If the multiplied frequency is included in the use communication frequency band, the controller 110 proceeds to S106, and otherwise ends the video input process.

The case where the multiplied frequency is included in the use communication frequency band includes not only a case where the interfering wave actually exists in the use communication frequency band, but also a case where there is a possibility that the interfering wave actually exists therein. That is, this embodiment performs the format change process when there is a possibility that the interfering wave actually exists in the use communication frequency even though the interfering wave does not actually exist therein.

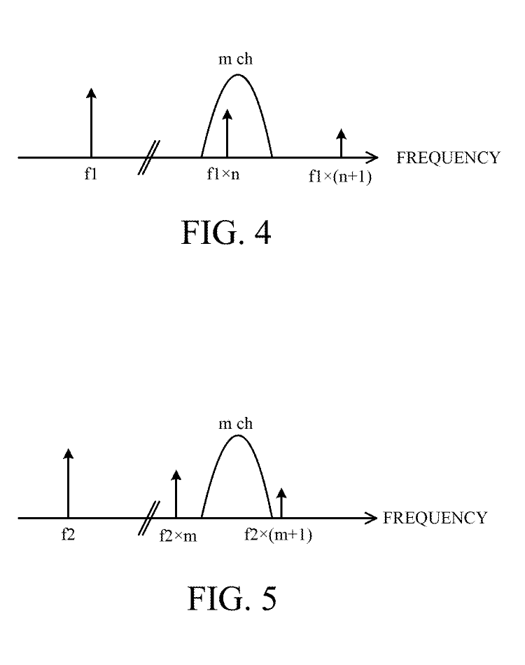

FIG. 4 illustrates, as an example, a video signal, interfering waves and a use communication frequency band of the wireless communicator 108 when the interfering wave exists in the use communication frequency band. A horizontal axis indicates frequency. In FIG. 4, f1 denotes the clock frequency of the video signal, and f1×n and f1×(n+1) (n is 2 or more integers) denote frequencies of the interfering waves as the integral multiples of the clock frequency. In FIG. 4, f1×n is included in the use communication frequency band mch (m is one or more integers) of the use channel. In such a case, the interfering wave generates wireless communication failures such as a communication disability between the wireless communicator 108 and the external communication apparatus and a decrease in communication speed.

Description will be made of an example of the interfering wave determination process performed by the interfering wave determiner 109. The interfering wave determiner 109 first calculates, from the information on the acquired use communication channel, n that makes f1×n maximum in a frequency band not exceeding a maximum frequency of the use communication frequency band. The interfering wave determiner 109 determines, when f1×n is equal to or higher than a minimum frequency of the use communication frequency band, that any of the integral multiples (f1×n) of the clock frequency is included in the use communication frequency band, that is, the interfering wave exists therein. On the other hand, the interfering wave determiner 109 determines that, when f1×n is lower than the minimum frequency of the use communication frequency band, the integral multiples of the clock frequency are not included in the use communication frequency band, that is, the interfering wave does not exist therein.

At S106, the controller 110 performs the format change process. Specifically, the controller 110 causes the format data changer 107 to change the video format data stored in the format data memory 106 such that the integral multiples of the clock frequency included in the changed video format are not included in the use communication frequency band. Then, the controller 110 proceeds to S107.

At S107, the controller 110 causes, in order to cause the video output apparatus 200 to reconfirm the changed video format data, the video processor 102 to perform a reconnection with the video output apparatus 200. In response to this reconnection, the video output apparatus 200 reads out the changed video format data stored in the format data memory 106, and outputs a video signal whose clock frequency is different from that before the change of the video format data. The controller 110 thus ends the format change process, and ends the video input process.

As described above, the controller 110 performs, when determining that the use communication frequency band of the wireless communicator 108 includes the frequency of the interfering wave that is the noise relating to the video signal, the format change process for causing the video output apparatus 200 to change the format of the video signal.

FIG. 5 illustrates the clock signal f2 of the changed video format, the integral multiples f2×m and f2×(m+1) (m is 2 or more integers) of the clock frequency and the use communication frequency band mch. A horizontal axis indicates frequency. In response to the format change process performed by the controller 110, the video output apparatus 200 changes the clock frequency of the output video signal as describe above. Thereby, the integral multiples f2×m and f2×(m+1) of the clock frequency of the output video signal are not included in the use communication frequency band mch of the wireless communicator 108. This results in reducing the generation of the wireless communication failures due to the interfering wave.

In the format change process, the controller 110 may cause the video output apparatus 200 to change the clock frequency of the video signal such that the integral multiples of the clock frequency are not included in the use communication frequency band of the wireless communicator 108, without causing the video output apparatus 200 to change the resolution of the video signal. Changing the blanking period that is another one element of the video format enables changing the clock frequency of the video signal while keeping the resolution unchanged. For example, shortening the blanking period enables outputting the video signal having the same resolution and a lower clock frequency. On the other hand, elongating the blanking period enables outputting the video signal having the same resolution and a higher clock frequency.

As a more specific example, description will be made of a case where the use communication frequency band of the wireless communicator 108 is from 2441 MHz to 2463 MHz, and the video signal whose clock frequency is 162 MHz and resolution is 1600×1200 is input from the video output apparatus 200. The interfering wave determiner 109 determines whether or not any of integral multiples of 162 MHz is included in the use communication frequency band. In this description, the interfering wave determiner 109 determines that a frequency (2450 MHz) of 15 times the frequency of 162 MHz is included in the use communication frequency band. That is, the interfering wave determiner 109 determines that an interfering wave exists (or may exist) in the use communication frequency band.

In this case, the controller 110 causes the format data changer 107 to change the video format data stored in the format data memory 106 to video format data indicating a video signal whose resolution is 1600×1200, whose blanking period is shortened and whose clock frequency is 130.25 MHz. Then, the controller 110 causes the video processor 102 to perform the reconnection with the video output apparatus 200. As a result, the integral multiples of the clock frequency of the video signal input from the reconnected video output apparatus 200 (that is, the frequencies of the interfering waves) are 2344.5 MHz and 2474.25 MHz that are 18 times and 19 times the frequency of 130.25 MHz, respectively. Thus, the frequencies of the interfering waves are not included in the use communication frequency band from 2441 MHz to 2463 MHz.

As described above, the projection unit (video display apparatus) 100 sets, depending on the data on the wireless communication frequency band (the data includes the use channel, the use communication frequency band and others), the format of the video signal receivable by the projection unit 100. This enables reducing the generation of the wireless communication failures without changing the resolution of the projected video displayed by the projection unit 100.

The controller 110 may cause the video processor 102, until the reconnection with the video output apparatus 200 is established at S107 (that is, until the projected video can be displayed using the video signal after its format is changed), to output the video signal immediately before the establishment of the reconnection to the panel driver 103. Thereby, a still image is displayed until the reconnection is established. However, compared with a case where no image is displayed, it is possible to make switching of the projected video unnoticeable for a user.

The above-described embodiment changes the video format data stored in the format data memory 106 when the determination that the integral multiple of the clock frequency, which corresponds to the frequency of the interfering wave, is included in the use communication frequency band is made. However, an alternative embodiment may change the video format data stored in the format data memory 106 when a determination that an interfering wave actually exists in the use communication frequency band is made by performing a frequency analysis.

Furthermore, the above-described embodiment performs the format change process such that the frequency of the interfering wave is not included in the use communication frequency band. However, another alternative embodiment may perform another format change process such that, in the use communication frequency band, the frequency of the interfering wave is changed to a frequency at which no wireless communication failure is generated.

### Embodiment 2

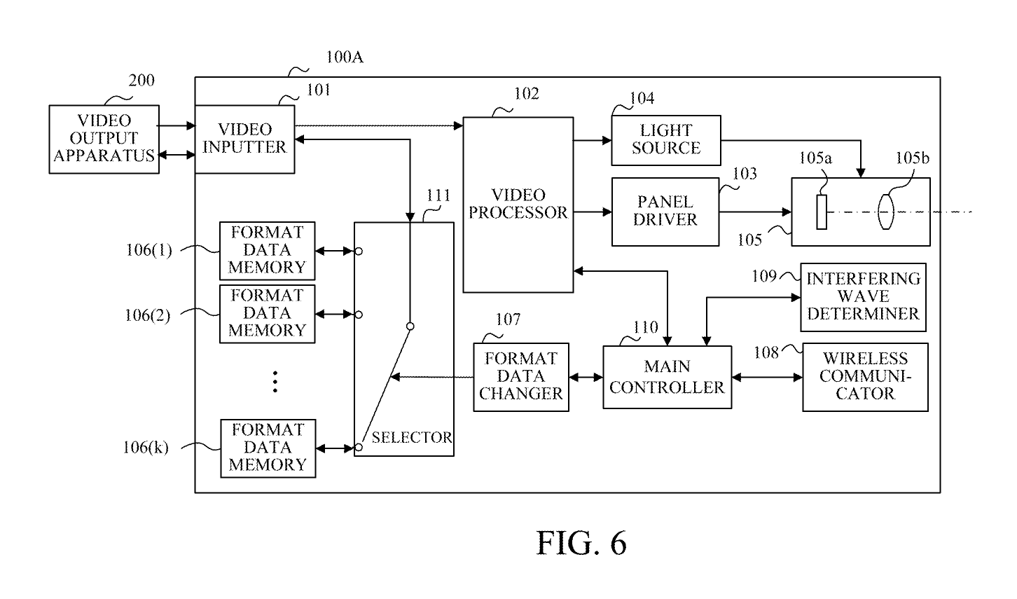

FIG. 6 illustrates a configuration of a projection unit 100A that is a second embodiment (Embodiment 2) of the present invention. In this embodiment, constituent elements common to those in Embodiment 1 are denoted by the same reference numerals as those in Embodiment 1, and their description is omitted.

The projection unit 100A of this embodiment includes multiple format data memories 106 (1 to k). Any one of the format data memories 106 (1 to k) is connected to the video inputter 101 via a selector 111. The format data changer 107 in this embodiment controls switching of the selector 111 in response to an instruction from the controller 110. The number of the multiple format data memories 106 (1 to k) corresponds to that of channels acceptable by the wireless communicator 108. The format data memories 106 (1 to k) store mutually different video format data used in the respective corresponding channels.

In this embodiment, the controller 110 controls the selector 111 to select one of the format data memories 106 (1 to k) to be connected to the video inputter 101, and thereby causes the video output apparatus 200 to read out one of the stored video formats. That is, the controller 110 performs a format change process for causing the video output apparatus 200 to change the format of the video signal output therefrom.

According to this embodiment, in order to cause the video output apparatus 200 to output the video signal corresponding to the changed video format data, it is only necessary to select one of the format data memories 106 (1 to k) to be connected to the video inputter 101. This enables, compared with Embodiment 1 that changes the stored video format data, reducing a time required for causing the video output apparatus 200 to output the video signal corresponding to the changed video format.

### Embodiment 3

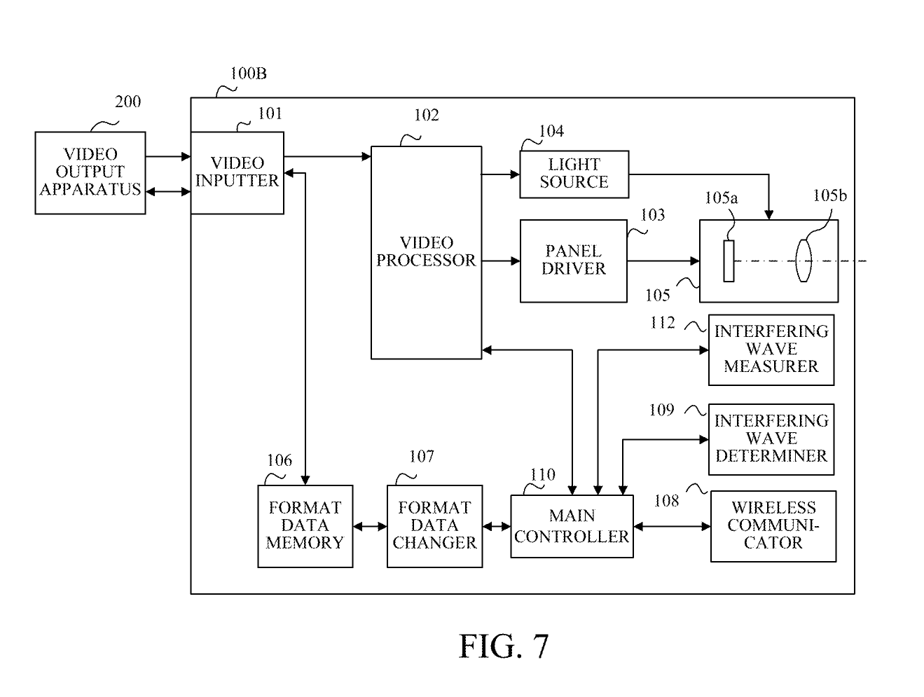

FIG. 7 illustrates a configuration of a projection unit 100B that is a third embodiment (Embodiment 3) of the present invention. In this embodiment, constituent elements common to those in Embodiment 1 are denoted by the same reference numerals as those in Embodiment 1, and their description is omitted.

The projection unit 100B of this embodiment includes an interfering wave measurer 112 that measures an intensity level of the interfering wave. The controller 110 performs the format change process described in Embodiment 1 when the integral multiple frequency of the clock frequency of the video signal is included in the use communication frequency band of the wireless communicator 108, and the measured intensity level of the interfering wave having the integral multiple frequency is higher than a predetermined level. The controller 110 may perform the format change process described in Embodiment 2 instead of that described in Embodiment 1.

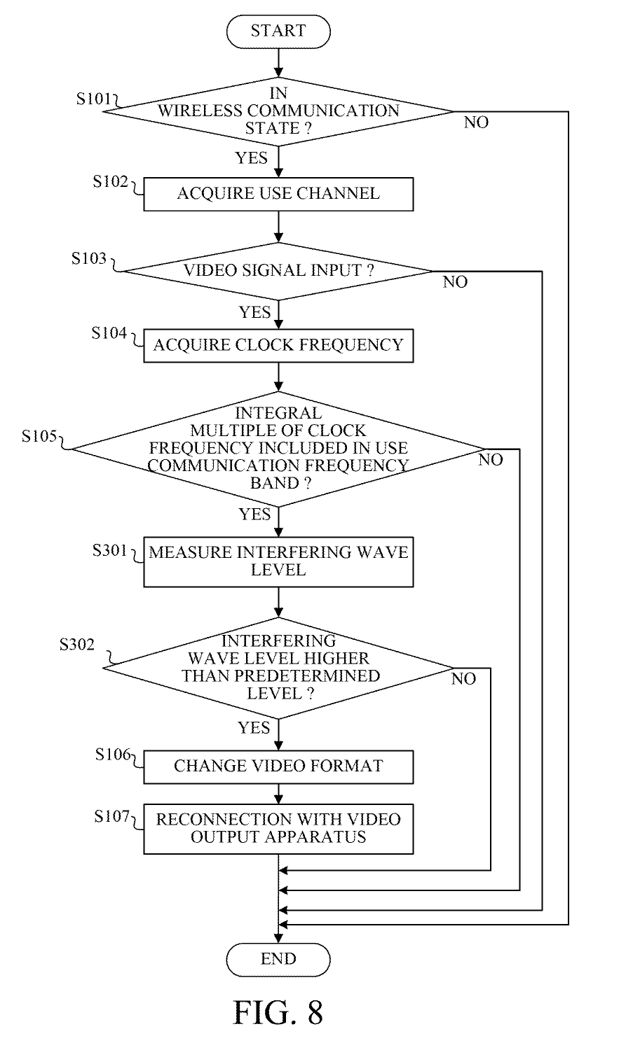

FIG. 8 is a flowchart of a video input process performed by the controller 110 in this embodiment. The controller 110 executes this process according to a video input process program as a computer program. S101 to S105 in FIG. 8 are identical to S101 to S105 in FIG. 3 of Embodiment 1.

When the interfering wave determiner 109 has determined at S105 that the integral multiple frequency of the clock frequency of the video signal is included in the use communication frequency band (that is, the interfering wave exists in the use communication frequency band) of the wireless communicator 108, the controller 110 proceeds to S301. At S301, the controller 110 causes the interfering wave measurer 112 to measure the intensity level of the interfering wave. Then, the controller 110 determines whether or not the measured intensity level of the interfering wave is higher than the predetermined level. The predetermined level corresponds to a level at which there is a high possibility that the interfering wave having such an intensity level causes wireless communication failures. If the intensity level of the interfering wave is higher than the predetermined level, the controller 110 proceeds to S106, and otherwise the controller 110 ends the video input process. S106 and S107 are identical to S106 and S107 in FIG. 3.

This embodiment changes the video format data stored in the format data memory 106 only when the interfering wave has an intensity level that causes the wireless communication failures with a high possibility. Therefore, this embodiment enables reducing frequency in changes of the video format data.

The above-described embodiment changes the clock frequency or the blanking period of the video signal as an element of the video format. However, an alternative embodiment may change other elements of the video format.

Furthermore, although each of the above embodiments described the projection unit, alternative embodiments of the present invention include other video display apparatuses than the projection unit, which each have a wireless communication function and receive an external video signal, such as direct-view monitors, tablet terminals and head-mounted displays.

As described above, the projection unit of each embodiment, which is capable of wireless communication, enables reducing the wireless communication failures caused by the video signal input from the external apparatus.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-045909, filed on Mar. 10, 2017, which is hereby incorporated by reference herein in its entirety.

What is claimed is:

1. A video display apparatus configured to display video using a video signal input from an external apparatus, the video display apparatus comprising:
a video inputter configured to receive the video signal;
a communicator configured to perform wireless communication; and
a controller configured to perform, using information on a communication frequency band of the wireless communication, a set process to set a format of the video signal receivable by the video display apparatus.

2. A video display apparatus according to claim 1, wherein the controller performs, when determining that the communication frequency band includes a frequency of noise relating to the video signal or that the noise exists, the set process such that the communication frequency band does not include the frequency of the noise.

3. A video display apparatus according to claim 1, further comprising a memory configured to store format data on the format of the video signal receivable by the video inputter and to allow the external apparatus to read the format data,
wherein the controller is configured to perform, as the set process, a process to change the stored format data.

4. A video display apparatus according to claim 1, wherein the controller is configured to, in the set process, cause the external apparatus to not change a resolution of the video signal as an element of the format.

5. A video display apparatus according to claim 1, wherein the controller is configured to, in the set process, cause the external apparatus to change a clock frequency of the video signal as an element of the format.

6. A video display apparatus according to claim 2, wherein the frequency of the noise is an integral multiple of a clock frequency of the video signal.

7. A video display apparatus according to claim 5, wherein the controller is configured to, in the set process, cause the external apparatus to change a blanking period of the video signal as an element of the format, thereby causing the external apparatus to change the clock frequency without causing the external apparatus to not change the resolution.

8. A video display apparatus according to claim 1, wherein the controller is configured to, until displaying the video using the video signal whose format is changed by the set process, display the video using the video signal whose format is not changed thereby.

9. A video display apparatus according to claim 3, wherein the video display apparatus comprising multiple memories, each being the memory, that store mutually different format data, and
wherein the controller is configured to perform, as the set process, a process to select one of the memories from which the reading of the format data is allowed.

10. A video display apparatus according to claim 2, further comprising a measurer configured to measure an intensity of the noise,
wherein the controller is configured to perform the set process when the intensity of the noise is higher than a predetermined level.

11. A projection unit configured to project and display video using a video signal input from an external apparatus, the projection unit comprising:
a light modulator that is driven by a drive signal produced using the video signal to modulate light from a light source; and
an optical system that projects the light modulated by the light modulator to a projection surface;
wherein the projection unit further comprises:
a video inputter configured to receive the video signal from the external apparatus;
a communicator configured to perform wireless communication; and
a controller configured to perform, using information on a communication frequency band of the wireless communication, a set process to set a format of the video signal receivable by the projection unit.

12. A non-transitory storage medium storing a computer program that causes a computer in a video display apparatus configured to receive a video signal from an external apparatus and to display video using the video signal and is capable of wireless communication, to perform processes, the processes comprising:
a step of acquiring information on a communication frequency band of the wireless communication; and
a step of performing, using the acquired data, a set process to set a format of the video signal receivable by the video display apparatus.
